(19) United States
(12) Patent Application Publication
(10) Pub. No.: US 2004/0066770 A1
(43) Pub. Date: Apr. 8, 2004

(54) Method for communicating with a resource-constrained device on an edge of a network

(76) Inventors: Kuldip Singh Pabla, Santa Clara, CA (US); Akhil K. Arora, San Jose, CA (US); Arvin C. Haywood, Mountain View, CA (US)

Correspondence Address: HOYT A. FLEMING III, P.O. BOX 140678, BOISE, ID, 83714, US

(21) Appl. No.: 10/266,337

(22) Filed: Oct. 7, 2002

(51) Int. Cl. H04Q 7/24; H04L 12/28

(52) U.S. Cl. 370/338; 370/401

(57) ABSTRACT

A method of requesting a service from a peer on a peer-to-peer network. The method includes entering a service request into a device and transmitting the service request to a relay-and-proxy on the peer-to-peer network. The method also includes converting the service request into a message and sending the message to the peer.

### 1. FIELD OF THE INVENTION

The present invention generally relates to peer-to-peer networks. More specifically, the present invention relates communicating with resource-constrained devices on the edge of a network.

### 2. BACKGROUND

Most Internet services are distributed using the client/server architecture. In this architecture, clients connect to a server using a protocol, such as the Transmission Control Protocol/Internet Protocol (TCP/IP) or File Transfer Protocol (FTP), to obtain access to a resource. Most of the processing involved in delivering the service occurs on the server. As a result, little processing occurs on the client.

Unfortunately, the client/server architecture has a major drawback. As the number of clients increases, the load and bandwidth demands on the server also increase. Thus, eventually a server cannot handle additional clients.

While almost all servers have fixed IP addresses, many computers that are utilized by Internet users have dynamic IP addresses, For example, when the user dials into an Internet-service-provider, the user is often assigned a dynamic IP address. Dynamic IP addresses effectively prevent many users from running the same server. While a user with a dynamic IP address can run a server, other users are prevented access to the server unless they know the other user computer's IP address beforehand. These computers form the “edge” of the Internet; they are connected to the Internet but are incapable of exchanging services.

2.1 P2P

Peer-to-peer (P2P) networks provide computers that are on the “edge” of the Internet with the ability to provide services to each other. Unlike client/server architecture networks, P2P networks do not rely on a centralized server to provide access to services. In fact, P2P networks usually operate outside of the Internet's domain name system.

The main advantage of P2P networks is that services are distributed among many computers on the network. Thus, service outages due to a single point of failure can be eliminated.

2.2 JXTA

In order to evolve P2P into a mature solution platform, P2P developers need a common language that allows peers to communicate and that performs the fundamentals of P2P networking. Sun Microsystems, Inc. formed project JXTA (pronounced juxtapose or juxta), to create such a language for P2P.

JXTA includes a number of protocols for P2P networking. One protocol, the peer discover protocol, enables peers to discover peer services on the network. A second protocol, the peer resolver protocol, allows peers to send and process generic requests. A third protocol, the rendezvous protocol, handles various details of propagating messages between peers. A fourth protocol, the peer information protocol, provides peers with the ability to obtain status information from other peers on the network. A fifth protocol, the pipe binding protocol, provides a mechanism to bind a virtual communication channel to a peer endpoint. A final protocol, the endpoint routing protocol, provides a set of messages used to enable message routing from a source peer to a destination peer. Each of these protocols is based upon eXtensible Markup Language (XML) messages. Additional information on these protocols can be found at http://spec.jxta.org/.

As a result of JXTA's protocols, JXTA provides a more abstract language for peer communication than prior P2P protocols.

### 3. SUMMARY OF INVENTION

One embodiment of the invention is a method of requesting a service from a peer on a peer-to-peer network. The method includes entering a service request into a resource-constrained device and transmitting the service request to a relay-and-proxy on the peer-to-peer network. The method also includes converting the service request into a message and sending the message to the peer.

Another embodiment of the invention is a method of obtaining a service on a peer-to-peer network. This method includes: entering a service request into a resource-constrained device; transmitting the service request to a relay-and-proxy on the peer-to-peer network; converting the service request into a first message; sending the first message to a peer; decoding the first message; processing the service request; generating a response to the service request; coding the response into a second message; sending the second message to the relay-and-proxy; decoding the second message; and transmitting the response to the resource-constrained device.

Still another embodiment of the invention is a method of obtaining a service on a peer-to-peer network. This method includes: entering a service request into a first resource-constrained device; transmitting the service request to a first relay-and-proxy on the peer-to-peer network; converting the service request into a first message; sending the first message to a second relay-and-proxy that is on the peer-to-peer network; decoding the first message; transmitting the service request to a second resource-constrained device; processing the service request; generating a response to the service request; transmitting the response to the second relay-and-proxy; coding the response into a second message; sending the second message to the first relay-and-proxy; decoding the second message; and transmitting the response to the resource-constrained device.

### 4. BRIEF DESCRIPTION OF THE FIGURES

FIG. 1 presents a JXTA peer-to-peer network.

FIG. 2 presents a flowchart of a method of obtaining a service from a peer on a peer-to-peer network.

FIG. 3 presents a flowchart of another method of obtaining a service from a peer on the “edge” of a peer-to-peer network.

### 5. DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

5.1. Resource-Constrained Devices

A new generation of devices that include cell phones, pagers, personal digital assistants (PDAs), devices using Tiny InterNet Interface (TINI) boards, and other consumer devices is rapidly entering the market. As a result, many users can subscribe to various services.

One difficulty in providing services for such devices is the limited resources present in such devices. For example, the amount of volatile and non-volatile memory is limited and typically is shared by several different applications. In addition, due in part to the fact that batteries supply electrical power for such devices, the processor performance for such devices is often modest.

As a result of the devices' limited resources, the types of applications that such devices can host independently are limited. However, a great potential for such devices is their ability to act as a portal into P2P networks that include more comprehensive computing and storage resources.

In many cases, even if a device includes significant internal resources, providing services for the device is still difficult because of limited network bandwidth and high network latency. For example, the device may communicate with a network via a wireless network link or via a modem dial-up link.

A device with limited resources as described above and/or a device that has a slow network link, such as a wireless or dial-up link, will be referred to as a “resource-constrained” device.

5.2 Java

A well-known programming language is Java. This programming language, which was developed in 1991 by Sun Microsystems, Inc., was designed to allow applications to run on all sizes of hardware platforms without modification.

5.3 Java 2

A second version of Java was also developed by Sun Microsystems, Inc. This version of Java is known as Java 2. Java 2 adds many enhancements to Sun's original Java. For example, Java 2 includes a Graphical User Interface (GUI) library, accessibility and 2-D libraries, drag and drop capabilities, support for audio files and digital certificates as well as enhanced security tools. Taken together, the Java 2 language, the Java 2 “virtual” machine, and the Java 2 Application Program Interface (API) compose a Java 2 platform. Java 2 platforms are designed to encompass a wide range of computer hardware, from smart cards to enterprise servers.

Recognizing that some tailoring was required to properly match Java 2 environments to their target hardware platforms, Sun Microsystems, Inc. developed three editions of Java 2. The first edition, Java 2 Standard Edition (J2SE), is designed for desktop computers. Typically J2SE runs on OS X, Linux, Solaris, or Microsoft Windows. The second edition, Java 2 Enterprise Edition (J2EE), is a comprehensive platform for multi-user, enterprise-wide applications. J2EE is based upon J2SE; however, it includes additional APIs for server-side computing. The third edition, Java 2 Micro Edition (J2ME), is a set of technologies and specifications developed for small devices.

5.4 Java 2 Micro Edition

J2ME is an edition of Java 2 for small devices such as Personal Digital Assistants (PDAs), smart cards, pagers, mobile phones, and set-top boxes. Because J2ME covers such a wide range of hardware devices, several different configurations and profiles of J2ME exist. A configuration is a specification that describes a virtual machine and a set of APIs that can be utilized on a certain class of device. Typically, a configuration does not specify enough detail to enable the building of complete applications. A profile builds on a configuration by adding specific APIs to make a complete environment for building applications.

One configuration of J2ME is the Connected Limited Device Configuration (CLDC). This configuration is for small wireless devices with intermittent network connections. Such devices include pagers, mobile phones, and PDAs. CLDC is suitable for devices with a 16/32-bit reduced instruction set computer (RISC) and complex instruction set computer (CISC) microprocessors and controllers with as little as 160 KB of memory.

One profile, which is based upon CLDC, is the Mobile Information Device Profile (MIDP). MIDP provides an API that includes support for a graphical interface and storage of persistent data for applications, which are known as MIDlets. MIDP is designed to work in the constrained environment of a wireless device. MIDP is suitable for mobile phones and two-way pagers.

5.5 Edge-to-Edge Communications

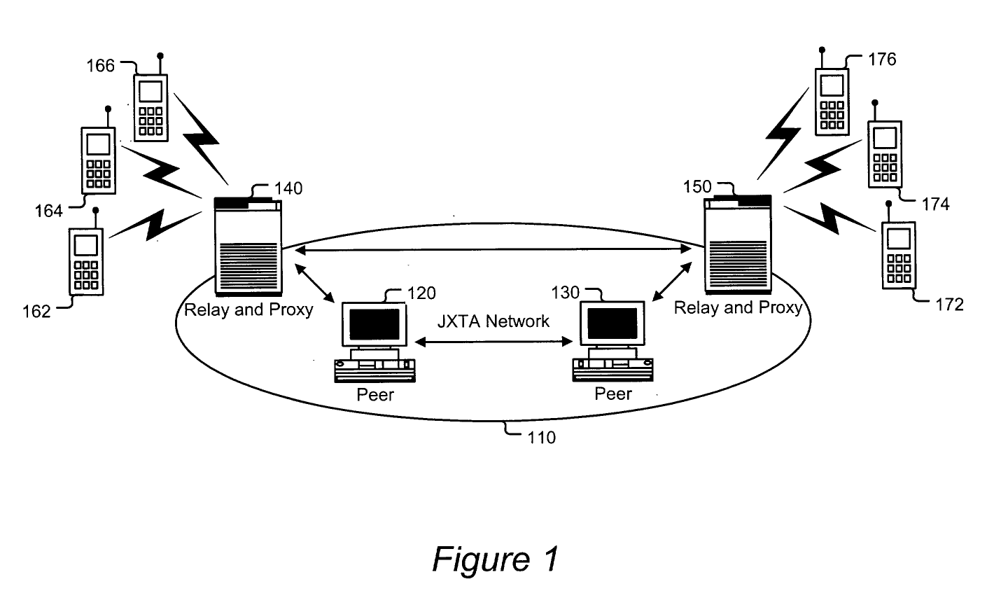

FIG. 1 presents a JXTA network 110. The network 110 includes a first peer computer 120 and a second peer computer 130. The first and second peer computers 120 and 130 can be any computer system such as a computer system running OS X, Linux, Solaris, or Microsoft Windows. In some embodiments of the invention, the first and second computer systems could be running J2SE over an operating system.

The JXTA network 110 also includes a first relay-and-proxy (RAP) 140 and a second relay and proxy (RAP) 150. The first and second RAPs 140 and 150 could be any computer system such as a computer system running OS X, Linux, Solaris, or Microsoft Windows. In some embodiments of the invention, the first and second RAPs could be running J2EE over an operating system that include a wireless transmitter/receiver.

The JXTA network 110 also includes a number of resource-constrained devices 162, 164, 166, 172, 174, and 176. These resource-constrained devices can be any resource-constrained device such as a mobile phone, a PDA, a TINI device, or a pager. In some embodiments the resource-constrained devices could comply with CLDC and/or MIDP.

As is shown in FIG. 1, a first group of the resource-constrained devices 162, 164, and 166 communicate with the first RAP 140. In some embodiments, these resource-constrained devices communicate with the first RAP 140 via a wide area wireless network such as iDEN network, PCS network, GSM network, GPRS network, 3G network, or PDC network. In other embodiments of the invention, resource-constrained devices 162, 164, and 166 communicate with the first RAP 140 via a local area wireless network such as an IEEE 802.11 network, or a Bluetooth network.

The first RAP 140 can communicate with the first peer 120 and the second RAP 150. In some embodiments of the invention, the first RAP 140 can communicate with most if not all peers of the JXTA network 110. In such embodiments, the first RAP 140 can also communicate with the second peer 130. (For clarity, such a communication is not shown in FIG. 1.)

The second group of resource-constrained devices 172, 174, and 176 communicate with the second RAP 150 via a wide area wireless network or via a local area wireless network.

Because of their resource constraints, the devices 162, 164, 166, 172, 174, and 176 can only act as “edge peers.” Thus, they cannot assume the role of more sophisticated peers that offer complex services to other peers in the JTXA network 110. However, the resource-constrained devices 162, 164, 166, 172, 174, and 176 can be utilized as windows into the JTXA network 110 by their users. As a result much of the processing involved in delivering a service occurs on a RAP 140 or 150 and/or a peer 120 or 130. For example, the first RAP 140 could provide interoperability with JTXA protocols between resource-constrained device 162 and the first peer 120. In addition, the first RAP 140 could perform user, group, and peer discovery for resource-constrained device 162. Further, the first RAP 140 could create pipes, create peer groups, join peer groups, and provide other communication tasks for resource-constrained device 162.

One communication task that could be performed by the first RAP 140 could be to filter JXTA traffic for resource-constrained device 162. Thus, only messages, which are also known as advertisements, that need to be received by resource-constrained device 162 would actually be sent to resource-constrained device 162. By filtering traffic, the first RAP 140 could conserve the limited bandwidth of resource-constrained device 162.

Another communication task that could be performed by the first RAP 140 could be to trim and/or optimize any messages that are sent to resource-constrained device 162. For example, JTXA messages are typically in XML format. While such format is easily decoded by more sophisticated peers, decoding XML messages can overwhelm the resource-constrained device. Thus, the first RAP 140 could decode an XML message and convert the decoded message into a more efficient format that conserves the limited bandwidth of resource-constrained device 162. In some embodiments of the invention, the first RAP 140 could, after converting the format of a message, immediately send the converted message to resource-constrained device 162. However in other embodiments of the invention, the first RAP 140 could store the message until resource-constrained device 162 polls the first RAP 140 with a request for the converted message.

5.6 Requesting a Service from a Sophisticated Peer

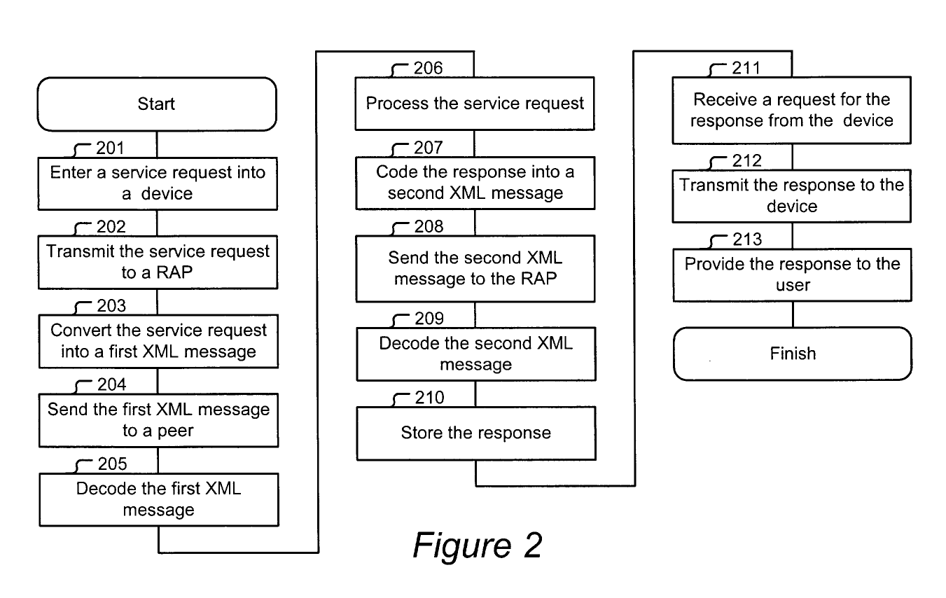

FIG. 2 presents a flowchart of the steps that could be performed when a user of resource-constrained device 162 requests a service from a sophisticated peer, such as the first peer 120.

First, as shown in Block 201, the user could enter a service request into resource-constrained device 162. The service request could be entered via a keyboard with feedback provided via a GUI on the screen of resource-constrained device 162. Alternatively, the service request could be entered via a handwriting-recognition program running on resource-constrained device 162. In addition, the service request could be entered via an audible request into a microphone installed in the resource-constrained device 162. In some embodiments of the invention, a combination of one or more of the above methods of entering a service request into resource-constrained device 162 could be used.

Next, as shown in Block 202, resource-constrained device 162 could transmit the service request to the first RAP 140. The service request could be transmitted via a wide area or a local area wireless network or even a combination of one or more wide area and local area wireless networks.

As shown in Block 203, after the first RAP 140 receives the service request, the first RAP 140 could convert the service request into a message format that is appropriate for a P2P network. For example, the first RAP 140 could convert the service request into an XML message for a JXTA P2P network.

Then, as shown in Block 204, the first RAP 140 could send the message to one or more peers on the P2P network. The message may be sent via any wide or local area network, such as the Internet or an Ethernet network, or even a combination of wide and local area networks.

As shown in Block 205, a peer could then decode the message. For example, the first peer 120 could decode the message. After decoding the message, as shown in Block 206, the peer could then process the service request and generate a response.

After the peer has generated the response, as shown in Block 207, the peer could code the response into a second message. Then, as shown in Block 208, the peer could send the second message to the first RAP 140. The first RAP 140, as shown in Blocks 209 and 210, could then decode the second message and store the response.

In some embodiments of the invention, the first RAP 140 could then immediately transmit the response to the resource-constrained device. However, as shown in Block 211, in other embodiments of the invention, the first RAP 140 could not transmit the response to the resource-constrained device until the first RAP 140 receives a request from the resource-constrained device to transmit the response.

As shown in Block 213, the resource-constrained device then provides the response to the user. In some embodiments of the invention, the response could be displayed on the resource-constrained device's display. In other embodiments of the invention, the resource-constrained device could provide the response to the user via the resource-constrained device's speaker.

5.7 Requesting a Simple Service from a Resource Constrained Device

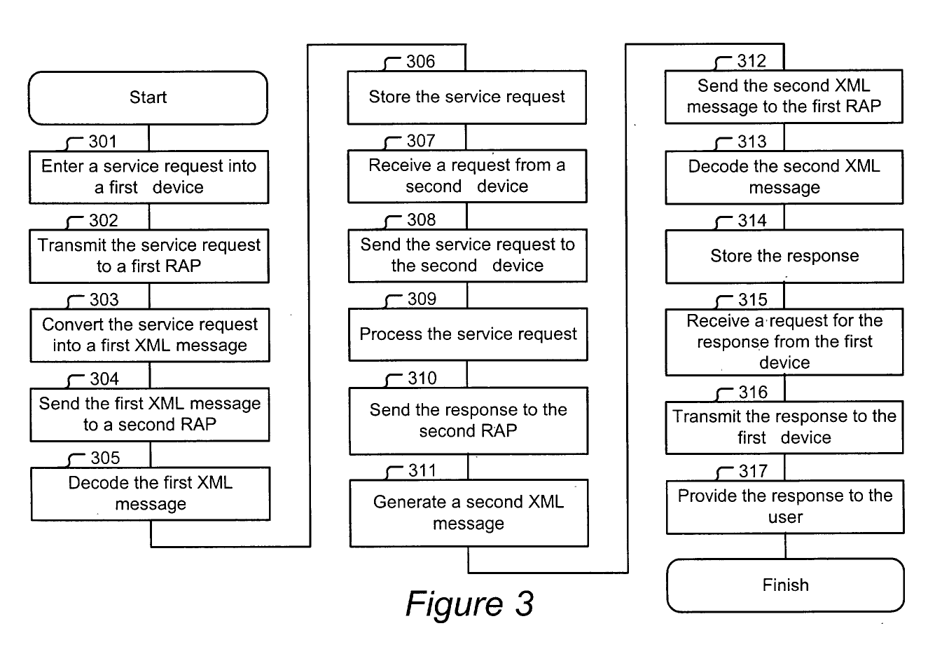

While resource-constrained devices have few resources, such devices can perform a limited number of simple services. FIG. 3 presents a flowchart of the steps that could be performed when a user of a resource-constrained device 162 requests a service from another resource-constrained device, such as resource-constrained device 172.

First, as shown in Block 301, the user could enter a service request into resource-constrained device 162. Next, as shown in Block 302, resource-constrained device 162 could transmit the service request to the first RAP 140. Next, as shown in Block 303, the first RAP 140 could convert the service request into a P2P network message. Then, as shown in Block 304, the first RAP 140 could send the message to the second RAP 150.

After receiving the message, as shown in Block 305, the second RAP 150 could decode the message. As shown in Block 306, the second RAP 150 could then store the service request. In some embodiments of the invention, the second RAP 150 could immediately transmit the service request to resource-constrained device 172. However, in other embodiments of the invention, such as shown in Blocks 307 and 308, the second RAP 150 would not transmit the service request to resource-constrained device 172 until the second RAP 150 receives a polling request from resource-constrained device 172.

After receiving the service request from the second RAP 150, as shown in Block 309, the resource-constrained device could process the service request. In some embodiments of the invention, processing the service request may require that the user enter data into the resource-constrained device. For example, the service request may seek information as to whether the user of resource-constrained device 172 is present, is within a certain geographical area, will attend a meeting, or is willing to accept a phone call.

After processing the service request, as shown in Block 310, resource-constrained device 172 could send the response to the second RAP 150. As shown in Blocks 311 and 312, the second RAP 150 could then generate and send a second message to the first RAP 140. Then, as shown in Blocks 313 through 316, the first RAP 140 could decode the second message, store, and transmit the response to resource-constrained device 162. Finally, as shown in Block 317, the resource-constrained device 162 could provide the response to the user.

5.8 Conclusion

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

It is claimed:

1. A method of requesting a service from a peer on a peer-to-peer network, the method comprising:
a) entering a service request into a device;
b) transmitting the service request to a relay-and-proxy on the peer-to-peer network;
c) converting the service request into a message; and
d) sending the message to the peer.

2. The method of claim 1 wherein the act of transmitting the service request includes transmitting the service request over a wireless network.

3. The method of claim 1 wherein the act of transmitting the service request includes transmitting the service request over a wired network.

4. The method of claim 1 wherein the act of converting the service request includes converting the service request into an XML message.

5. The method of claim 1 wherein the act of converting the service request includes converting the service request into an XML message that is compliant with a JXTA protocol.

6. A method of obtaining a service on a peer-to-peer network, the method comprising:
a) entering a service request into a device;
b) transmitting the service request to a relay-and-proxy on the peer-to-peer network;
c) converting the service request into a first message;
d) sending the first message to a peer;
e) decoding the first message;
f) processing the service request;
g) generating a response to the service request;
h) coding the response into a second message;
i) sending the second message to the relay-and-proxy;
j) decoding the second message; and
k) transmitting the response to the device.

7. The method of claim 6 wherein the act of transmitting the service request includes transmitting the service request over a wireless network.

8. The method of claim 6 wherein the act of transmitting the service request includes transmitting the service request over a wired network.

9. The method of claim 6 wherein the act of converting the service request includes converting the service request into an XML message.

10. The method of claim 6 wherein the act of converting the service request includes converting the service request into an XML message that is compliant with a JXTA protocol.

11. The method of claim 6, wherein the act of transmitting the response includes: storing the response, receiving a request for the response from the device, and then sending the response to the device.

12. The method of claim 6, further including:
1) providing the response to a user.

13. A method of obtaining a service on a peer-to-peer network, the method comprising:
a) entering a service request into a first device;
b) transmitting the service request to a first relay-and-proxy on the peer-to-peer network;
c) converting the service request into a first message;
d) sending the first message to a second relay-and-proxy that is on the peer-to-peer network;
e) decoding the first message;
f) transmitting the service request to a second device;
g) processing the service request;
h) generating a response to the service request;
i) transmitting the response to the second relay-and-proxy;
j) coding the response into a second message;
k) sending the second message to the first relay-and-proxy;
l) decoding the second message; and
m) transmitting the response to the device.

14. The method of claim 13 wherein the act of transmitting the service request to the first relay-and-proxy includes transmitting the service request over a wireless network.

15. The method of claim 13 wherein the act of transmitting the service request to the first relay-and-proxy includes transmitting the service request over a wired network.

16. The method of claim 13 wherein the act of converting the service request includes converting the service request into an XML message.

17. The method of claim 13 wherein the act of converting the service request includes converting the service request into an XML message that is compliant with a JXTA protocol.

18. The method of claim 13, wherein the act of processing the service request includes receiving input from a user.

19. The method of claim 13, wherein the act of transmitting the response to the first device includes: storing the response, receiving a request for the response from the first device, and then sending the response to the first device.

20. The method of claim 13, further including:
n) providing the response to a user.
